(19) United States
(12) Patent Application Publication
(10) Pub. No.: US 2015/0097403 A1
(43) Pub. Date: Apr. 9, 2015

(54) Mounted Seatbelt Buckle Stabilizer Retrofit Device, Incorporated Seatbelt Buckle Stabilizer Booster Seat, & Incorporated Seatbelt Buckle Stabilizer Booster Seat Cover Device

(71) Applicant: Wayne London, Sebring, FL (US)

(72) Inventor: Wayne London, Sebring, FL (US)

(21) Appl. No.: 14/047,945

(22) Filed: Oct. 7, 2013

(51) Int. Cl. B60N 2/28; B60N 2/26

(52) U.S. Cl. CPC B60N 2/2803; B60N 2/265; B60N 2/2866; B60N 2002/2815
USPC 297/250.1; 297/463.1

(57) ABSTRACT

An incorporated booster seat device, an incorporated booster seat cover device, and a mounted attachment configuration for stabilizing a flexible female seatbelt buckle from primarily, but not limited to, a booster seat or other proximity structure; having a structured configuration that includes suspending, saddling and enclosing the flexible female seatbelt buckle in a holster fashion; to facilitate the positive engagement of the seatbelt buckle. The attachment configuration is provided as a retrofit for the millions of booster seats that lack the benefits of this invention; and also as an attachment for existing standalone proximity structures and objects that benefit from its application.

### BACKGROUND OF THE INVENTION

Our three kids are the reason why this ingenious product was invented. As a husband, I was not comfortable with my beautiful wife, taking-off in frustration after experiencing the seatbelt buckling confusion with three kids in the backseat. After searching online and in many parenting catalogs, we did not find any product to solve this problem at all. It broke my heart because she is so “so sweet”. Driving kids with that state-of-mind cannot be good for anybody. As a Senior R&D Engineer, I knew I had to do something about the everyday buckling-up problems with three booster seat kids in the backseat. Ever since the first prototypes have been installed, all our kids are so happy that they can buckle themselves-up. Now, when we get in the car, they automatically buckle themselves up; and every so often they yell “Buckle-Up Mommy or Daddy” as soon as they fasten their own seatbelts. For them, this is a “big” accomplishment and they are very proud of it. We as parents have given our kids something we all are proud of.

Our family believes that ever family should benefit from this invention the way our family has.

Once children out grow their forward facing child safety seats around the age of 4 years old and 40 pounds, by law, they must always travel in booster seats. This lawful recommendation requires the use of a booster seat up to 4 feet 9 inches tall or 8 to 12 years old. In addition, to these booster seat requirements the lawful recommendation also state that children should ride in the back seat until the age of 13 years old.

Many parents, guardians and transporters spend a lot of time buckling the seatbelt for their booster seat kids; because these little kids are not yet strong enough to hold both the male and female buckles of the seatbelt and buckle themselves up. Sometimes forgotten for many reasons, moments after they take off, drivers have to safely pullover, stop, get out of the car and buckle their booster seat kids up. This event is normal for the average driver; we do it because of the law and for the known safety advantage of our kids. In addition, to managing kids who insist that they can buckle themselves up but, cannot; parents and guardians on the go do not want to waste any extra time (if they do not have to) frequently buckling their kids up.

As simple, joyful and responsible as buckling up ones toddler in the backseat may appear, this frequent everyday activity wastes unnecessary time and, increases stress and frustration. Not to mention, the various ailments that parents and guardians have to deal with, given the numerous obstacles of the many makes and models of automobiles available today, in order to fasten a child's seatbelt.

There are hundreds of millions of passenger cars in the United States today that are not equipped with a rear seatbelt that can be fastened with only one hand or by booster seat kids. Many vehicles and millions more are being made and sold every year with flexible female seatbelt buckles in the backseat. And at this rate, it does not seem like these vehicles are going to phase out these flexible seatbelts anytime soon. Moreover, the design and application of these flexible seatbelts are economic and practical for the majority of consumers and automakers.

Competitive kids who believe that they can do everything by themselves will enjoy this new and novel feature as part of their booster seat at all times. Parents using this featured product on their booster seats will certainly have one less thing to do and worry about. And these parents will also, now be able to verbally instruct booster seat kids to buckle themselves up instead of having to do it for their kids every time; until their kids become strong enough to hold both buckles and buckle themselves up.

Included in the background of this invention is the reference to an existing U.S. Pat. No. 7,862,125B2. The previously mentioned patent covers the support structure of the splinting and wedging configurations, which is anchored to the flexible female seatbelt buckle on the seat of the vehicle. An elaborate (Background-Of-The-Invention under Prior-Art) description of Child Seats, Booster Seats, Several Manufacturers of these Products and US Federal Government Seatbelt Laws can be found there and need not be repeated here. Also included in this reference are a detailed description of how a seatbelt works and the concept of how it is supposed to function.

The Mounted Seatbelt Buckle Stabilizer does not apply to combination booster seats that have a harness built into the seat. The combination booster seat is usually secured to the vehicle seat. In this case, the built-in harness is used to secure the child or booster seat kid. The Mounted Seatbelt Buckle Stabilizer is, simply, a buckle up helper.

The versatile quick-snap Mounted Seatbelt Buckle Stabilizer is primarily a booster seat with an incorporated attachment, an incorporated seatbelt buckle stabilizer booster seat cover device, and an add-on retrofit that suspends or encloses the flexible female seatbelt buckle in a holster fashion; to facilitate the positive engagement of the seatbelt buckle. The add-on attachment and the cover configurations are provided as a retrofit for the millions of booster seats that lack the many benefits of this invention. The suspension or holster enclosure or other configurations can also be incorporated into an improved booster seat or booster seat cover; yet to be manufactured. The Mounted Seatbelt Buckle Stabilizer also provides the ability to suspend any multitude of objects on a surface with the flexibility to quickly connect, retain and release the suspended or restrained object(s). The Mounted Seatbelt Buckle Stabilizer attachment also functions as a standalone for small objects or in an array of quick-connect or quick-release clamping devices to suspend larger objects on any surface or mounting positions. The quick-snap belting configuration is also capable of retaining (receiving and holding) other objects than the seatbelt buckle to the booster seat.

The quick-snap Mounted Seatbelt Buckle Stabilizer provides positive back seat buckling and unbuckling assistance. It is a novel quick snap-on attachment, mounted on the booster seat, for the stabilization of the flexible female buckle of a seatbelt. Many booster seat kids are strong enough to buckle themselves up if they were assisted by someone holding the female buckle steady so, that they can push only the male buckle to fasten the seatbelt. In other words, the function of this new and novel juvenile product is used to create a stabilized base for the flexible female seatbelt buckle, enough, for the slightly-able booster seat kid to become fully-capable of buckling themselves up without any assistance. This kids friendly quick-snap Mounted Seatbelt Buckle Stabilizer retrofit attachment and incorporated configurations are of the suspension and holster enclosure type application. These Mounted Seatbelt Buckle Stabilizer configurations attaches to itself and the booster seat; not to the seatbelt nor to the back seat of the car, forming a collar or column around the flexible webbing of the base of the female buckle; while permitting the seatbelt restraint to function the way it was intended. Consequently, by design, this product will not augment nor diminish the Federal Government's strength and safety standards for seatbelt restraint. The Mounted Seatbelt Buckle Stabilizer is, simply, novel a buckle up helper.

### DESCRIPTION OF PRIOR ART

The latest products and patented products have staked their claims but have not yet fully solved the above-mentioned problems. They provide the various accessories fixed, detachable, retractable and adjustable which are all incorporated into the most modern booster seat. However, these booster seats have not yet addressed the movable and flexible seatbelt buckle stabilization problem for booster seat kids. Again, in the referenced patent found above, but no product on the market yet, has attempted to address this problem but it merely focuses on the stabilization of the seatbelt by using a support structure of splinting and wedging configurations. This device by its limited design intentions is mounted permanently or anchored to the flexible female seatbelt buckle and the vehicle's seat. It lacks the flexibility of automatically transferring the device with the booster seat when it is transferred from one vehicle to another. This device fails to help the masses of booster seat kids who have to use a different vehicle for a multitude of reasons; given that it is cheaper, easier and more convenient to quickly transfer the booster seats for the safety of our children. This device attached on the seat of the vehicle is an inconvenience for passengers who will accidentally sit and slide on it. Such an obstacle would consume more time and effort to navigate and manage its removal and reinstallation, which means the device can also be misplaced. The solution this device provides the consumers will always come at an additional cost since it is not incorporated or attached to the booster seat. These devices were supposed to be created to also meet the time saving demand.

In addition to the existing technology mentioned above, there are also many shoulder belt positioners that are used to adjust the shoulder belt position on the child. These models can be integrally formed into the booster seat (such as U.S. Pat. No. 5,997,098A, typically on high back applications) and separately detached from the booster seat (such as U.S. Pat. No. 4,609,205 and US2002/00117808A1, typically used on low-back and no-back applications). Another part of the seatbelt industry considers the prevention of booster seat kids from sliding under the lap portion of the seatbelt (also known as “Submarine-ing”). So, Britax Parkway, one of the leading companies in child passenger safety technology has incorporated the anti-submarine-ing technology (called SecureGuard) into their Parkway SG model. The SecureGuard clip assures that the lap belt is properly positioned below the child's hips. The child is also capable of putting on this clip, which creates a fourth seatbelt entry point between the child's legs. The list is actually longer than the few references mentioned in this paragraph but the point to mention their existence is both necessary and relevant.

### SUMMARY OF THE INVENTION

The versatile quick-snap Mounted Seatbelt Buckle Stabilizer and incorporated configurations are primarily a booster seat attachment device that suspends, saddles and encloses the flexible female seatbelt buckle in a holster fashion; to facilitate the positive engagement of the seatbelt buckle. The attachment configurations are provided as a retrofit for the millions of booster seats that lack the benefits of this, buckle up helper, invention. The suspension, saddling or holster enclosure configuration can also be incorporated into an improved booster seat or a booster seat cover. The Mounted Seatbelt Buckle Stabilizer also provides the ability to suspend any multitude of objects on a surface with the flexibility to quickly connect, retain and release the suspended or restrained object(s). The compact Mounted Seatbelt Buckle Stabilizer attachment also functions as a standalone device for small objects or in an array of quick-connect or quick-release clamping devices to suspend larger objects on any surface or mounting position. The quick-snap belting configuration is also capable of retaining (receiving and holding) other objects including the seatbelt buckle to the booster seat.

Note: The incorporated configurations herein refer and apply equally to both the incorporated booster seat device and the incorporated booster seat cover device. This is intended to also improve clarity by reducing the repetition of the description of configurations for multiple devices. Given that the various configurations stated herein generally cover an incorporated booster seat device, a mechanically attached, hardware, retrofit device, and a non-intrusively attached covering or pull-over, fabric, retrofit device.

The quick-snap Mounted Seatbelt Buckle Stabilizer and incorporated configurations provide positive backseat buckling and unbuckling assistance. It is a novel quick snap-on attachment, mounted on the booster seat, for the stabilization of the flexible female buckle of a seatbelt. Many booster seat kids are strong enough to buckle themselves up if they were assisted by someone holding the female buckle steady so, that they can push only the male buckle to fasten the seatbelt. In other words, the function of this new and novel product is used to create a stabilized base for the flexible female seatbelt buckle, enough, for the youngest booster seat kids to become capable of buckling themselves up without any assistance. This kid friendly quick-snap Mounted Seatbelt Buckle Stabilizer retrofit attachment and incorporated configurations are of the suspension and holster enclosure type application. These Mounted Seatbelt Buckle Stabilizer configurations attach to itself and the booster seat, not to the seatbelt or the vehicle seat, forming a collar or column around the flexible webbing at the base of the female buckle; while permitting the seatbelt restraint to function the way it was intended. Consequently, by design, this product will not diminish the Federal Government's strength and safety standards for seatbelt restraint because after bucking the seatbelt is fully disengaged from the stabilizer.

The Mounted Seatbelt Buckle Stabilizer and incorporated configurations provide an easy, smart, affordable, practical and reliable parenting solution and at the same time gives our juveniles the early independence they so desire. The seatbelt stabilization via this novel invention is a major improvement to the most modern booster seats. The retrofit configuration device can also be used in many other applications where a frequent quick attach and quick release are required.

Popular booster seat models, by design intent, sit freely on the vehicle's seat. The design intent of an unrestrained booster seat is that it better protects or cushions the child in case of a head on collision and the child is thrown forcefully forward on the seatbelt and forcefully backward on the booster seat. Most crash test videos show the booster seats moving as far as the seat and the seatbelts would allow the child to move. The relative movement of the booster seats with respect to their original position is not significant but, it is enough for better cushioning.

On the other hand, an unrestrained booster seat can slide out from under the bottom of a child, especially, a child that wants it so. When this happens, the child becomes dangerously unsecured. At other times, when the unrestrained booster seat is not being used it can become a very dangerous projectile for anyone sitting in its path.

This invention of a Mounted Seatbelt Buckle Stabilizer device provides a convenient solution to semi-restrain the booster seat while allowing it to:
(1) Benefit from the cushioning effect of an unrestrained booster seat.
(2) Prevent the unrestrained booster seat from becoming a dangerous projectile.
(3) It does not allow a willing child to slide the booster seat out from under their bottom; hence, eliminating the possibility of the child being in this dangerous unsecured position.

Simply put, the Mounted Seatbelt Buckle Stabilizer incorporated into the booster seat, or booster seat cover, or retrofitted, is the all around smarter solution for the stabilization of the flexible seatbelt buckle; and the missing piece of booster seat technology. When the Mounted Seatbelt Buckle Stabilizer is mounted to the booster seat, the convenience, of the buckle up helper, is truly realized.

The retrofit configuration, FIG. 1, consists of a mounting plate with multiple belt adjustment slots used to mount the device onto a surface such as a booster seat. Just a screwdriver is required for installation. The drill point lathe screw utilized is capable of attaching to wood, plastic and even metal surfaces without the requirement of a pilot hole from a drill bit. Said configuration includes two appropriately sized quick release buckles for ease of use; two belts capable of locking onto very small objects and of reduced scale of its normal function; and necessary accompanying locking sliders. The function of the mounting plate is mainly to set and maintain the appropriate belting width, reduce the stress and wear of the belting so that the device can function effectively and last longer. It also provides adequate collinear and opposing tension in belts for the slider to lock the belts into place. These sized belts are the perfect fit to suspend the female seatbelt buckle when it is mounted and attached below the lower surface of the female seatbelt buckle. The suspending application provides the upward force necessary to counteract the downward force applied to buckle to latch the seatbelt. At the same time, the upper belt encloses the body of the flexible female seatbelt buckle, FIG. 3, and provides the stabilization necessary for the seatbelt engagement. The belted configurations are slender, unobtrusive and more compact than non-belted. Another useful characteristic of the belted configuration is the quick release capability to allow for easy uninstall and installation. Consequently, the mounting plate requirements are dependent but not limited to the belting selection applied.

The retrofit configuration, FIG. 2, can take many forms based on the material selection of the device. A sheet metal or plastic holster configuration by design, in this case, is bottomless configuration. The design and installation of the split, continuous and overlapping bottomless holster enclosures, FIGS. 11-14, are arranged to permit the flexible female seatbelt to rest on the vehicle seat to provide the upward force necessary to counteract the downwards force applied to the buckle to latch the seatbelt. However, the design and installation encompasses the body of the flexible female seatbelt buckle even as it retracts into the vehicle seat and provides the stabilization necessary for the seatbelt engagement along this range of displacement. In other words, the holster enclosure configuration will not allow the flexible female seatbelt buckle to slip out of the enclosure when a downward force is applied. The upward drafted perimeter, FIG. 14, is incorporated into the design to always keep the buckle encapsulated and not protrude or rub on the vehicle seat. This design is requires more room than the slender compact belted configuration above. However, installation of the holster enclosure configurations only require that the flexible female seatbelt buckle be fed through the enclosure and installation is complete. This overlapping configuration, FIG. 12, is made of only two identical brackets flipped and assembled to complete the unit. One more useful characteristic of the holster enclosure configurations are the quick install and removal capability of the booster seat.

The Mounted Seatbelt Buckle Stabilizer is a practical, working and convenient parenting solution also gives all booster seat kids their independence. When this device is incorporated or retrofitted to the booster seat, booster seat kids can easily transfer the booster seat themselves from one automobile to another by just picking it up from one vehicle seat and placing it into another. It is this easy, when booster seat have this configuration of the seatbelt buckle stabilizer device incorporated or retrofitted to their booster seat. The Mounted Seatbelt Buckle Stabilizer device, FIG. 4, can be configured as a slender bracket with two quick release belts attached to it; or a protruded enclosure that holsters the flexible seatbelt buckle. The belt type configuration, FIG. 3, suspends and captures the flexible female seatbelt buckle while the holster configuration feature just captures it in the upright position. Both of these booster seat configurations stabilize the flexible female seatbelt buckle, which assists the booster seat kids in buckling themselves up without assistance. Depending on the configuration, to install the retrofit version on an existing booster seat without this feature requires at least one or two screws or the application of the incorporated seat cover device.

The Mounted Seatbelt Buckle Stabilizer is a practical and reliable parenting solution. In its many configurations, this device is a major improvement and addition to booster seat features. Here, the Mounted Seatbelt Buckle Stabilizer retrofit configuration of this device is presented in detail to provide instructions for manufacturing purposes, FIG. 4.

The Mounted Seatbelt Buckle Stabilizer retrofit device is comprised of:
(1) FIG. 5, carefully sized dual 5/8 in belting; small enough for the functionality but, big enough for the buckling and unbuckling operation. Any dual belting size bigger looses functionality but, increases in operation. Any dual belting size smaller, reduces the operation of the device but, increases in functionality or how the device works.
(2) The quick-snap quick-release buckles were selected over the use of Velcro belting because the thicker Velcro is more easily undone by booster seat kids than the quick-release buckles.
(3) Due to the scale and severity of the application, the locking slides were selected to reduce or eliminate the occasional slip that occurs in their absence.
(4) The quick-snap plastic buckles provide for rapid buckling and unbuckling while retaining and repeating any previous set adjustments. The Velcro belting lacks this repeatability thus; it would require a higher degree of adjustment when utilized.
(5) Overall, the belting configuration provides for a more slender compact and non-obstructive application of this device. The quick-release buckle and webbing belting selection is merely the preferred option to date, over Velcro and other belting options.
(6) The #8 drill-point lathe screw is selected for its capacity to pierce all common non-metal material and sheet metal. The installation of the drill-point screw is done without the requirement of a pilot hole; since it is capable of creating its own pilot hole.
(7) The carefully sized 1.5 mm to 2 mm thick stainless steel mounting plate, FIG. 6, is a simplified mechanism for preventing the belting from being pierced. The mounting plate reduces the wear and stress on the belting. It also provides the minimum opposing forces on the belting for the locking slides to function while setting the appropriate belting width. The mounting plate hole-pattern provides multiple belting arrangement options, FIG. 10A and FIG. 10B. And as such, it provides single structure attachment unit and a single structure for mounting all the subsequent parts to unify the device. The retrofit configuration of this device is mounted as shown in FIG. 7. The perspective of scale is shown in FIG. 8 to depict the relative size of this retrofit device and the belting. FIG. 9 takes it one step further to depict the scale of the device installed in the backseat bench of a compact vehicle.
The availability of a stronger and more compact (very thin) Velcro belting can reverse the selection in its favor.

The single or multiple belting configurations by itself can be incorporated into the booster seat as a segmented, FIG. 24, or continuous, FIG. 23, belting solution. Said single belting configuration is supplemented with a saddling mounting plate, FIG. 30, instead of the simplified mounting plate mentioned above, FIG. 6. The top, front and side views of the saddling mounting plate are shown in FIG. 29, FIG. 31 and FIG. 32 respectively. The saddling configuration comprises of both rigid and flexible saddling structure; given, that saddling pertains to the through-the-flexible-female-belt loop, FIG. 33, and suspending pertains to the around-the-flexible-female-belt loop, FIG. 10A. FIG. 34 shows the side view of a rigid saddling application; given that the flexible counterpart would have belting passing through the flexible female belt loop. The bent saddling tabs on both top and bottom ends are configured to use the same part in for left or right hand application. Said bent tab design is configured for quick and easy installs and uninstalls.

Given that there is an existing Seatbelt Buckle Adapter or Extension which can be modified with little effort to accomplish the same task of the incorporated and retrofit devices claimed herein, FIG. 35 shows an example of the modification necessary to accomplish this task. The modification requires compatible pair a adapter mounting features to connect to the booster seat. FIG. 36 shows an example of the booster seat modification necessary to complete this task. And FIG. 37 shows a working example of both the incorporated and retrofit application of the Seatbelt Buckle Adapter or Extension configuration.

Finally, it can be said, that the incorporated seatbelt buckle stabilizer booster seat cover is merely a booster seat cover, made from composite fabric, that incorporates all the necessary features of the incorporated booster seat and the retrofit configurations described herein. And FIGS. 38A-D show four views of a working example of the incorporated seatbelt buckle stabilizer retrofit configuration in its formed state to assume how it is supposed to function. These figures also shows the incorporated seatbelt buckle stabilizer booster seat cover is comprised of necessary cutouts to provide access to the auxiliary features of the booster seat application which includes but, not limited to, the incorporated arm rest and cup holder features of the booster seat.

The incorporated seatbelt buckle stabilizer booster seat cover configuration can be configured as one size fits multiple booster seats with various fitting and connection strategies. The connection strategy of the incorporated seatbelt buckle stabilizer booster seat cover configuration includes but, not limited to temporary and permanent, elastic fabrics, zippers, buttons, quick snaps, hook and loops, adjustable composite pieces of formed fabrics, straps and belting, and Velcro connection and fitting features.

### DRAWING DESCRIPTION

The drawings illustrate some exemplary embodiment configurations; consisting of a Mounted Seatbelt Buckle Stabilizer device: both retrofits for existing booster seats and incorporations into improved booster seats. The illustrated drawings are shown with emphasis on clarity and therefore the Mounted Seatbelt Buckle Stabilizer is orientated orthogonally to the booster seat in some cases. A variation in the angle of these devices and their walls minimally affect the function of this application. A limiting or biased pivoting hinge can be incorporated to adapt to the natural angle of alignment of the seatbelt buckle when in use. The material and construction descriptions used are merely an economic reflection of the material and construction used for the final production configuration; however, other suitable materials and constructions are available. The configurations shown may demonstrate a flexible or rigid construction, however, in some cases either both or one may be depicted. In the case where only one is depicted for simplicity the others are automatically implied.

FIG. 1: Retrofit Device Configuration comprising mounting plate, mounting screw, quick release buckle, belting, and locking slide. Mounting plate displays minimum width to create collinear/opposing tension on belts. Belts located at extremes of mounting plate adjustment slots for larger seatbelt buckle accommodation. Slides adjusted close to quick release buckle for maximum belt lock.

FIG. 2: Rear View of Retrofit Device Configuration showing mounting plate slots, belt installation rear view and installation drill point screws.

FIG. 3: View of Retrofit Device Configuration showing flexible female seatbelt buckle in stabilized position.

FIG. 4: Exploded View of Retrofit Device Configuration showing, piecewise, mounting plate, belting, screw, buckle, and slide. For manufacturing purposes, the bill of materials shows 1 sized stainless steel mounting plate, 2 polypropylene belts of adequate lengths, 2 plastic quick-release buckles, 4 plastic sliders, and 2 drill point screws.

FIG. 5: Section View of Retrofit Device Configuration showing the belt threading through the mounting plate and all other components for this configuration. Both upper and lower belts are threaded similarly. This figure also provides the view of assembly mechanics.

FIG. 6: View of Retrofit Device Configuration showing a practically sized mounting plate. The dimensioning scheme is of dual dimensions (both English and Metric) where values are displayed as “inches [millimeters]”. The general function of this bracket permits it to be customized to any configuration of hole-patterns, -shapes and -sizes.

FIG. 7: Partial View of Retrofit Device Configuration situated in a mounted booster seat setting to display how the retrofit device is mounted to a standard booster seat.

FIG. 8: Full View of Retrofit Device Configuration situated in a mounted booster seat setting, as in FIG. 7 but, this full page view depicts the scale or size of the retrofit device.

FIG. 9: View of Retrofit Device Configuration situated in a mounted booster seat setting with the flexible female seatbelt buckle being captured by the device.

FIG. 10A: View of Retrofit Device Configuration situated in a mounted booster seat setting with the flexible female seatbelt buckle being captured by the device; while being in the back bench of an automobile. The Belting is shown in the top most position.

FIG. 10B: View of Retrofit Device Configuration situated in a mounted booster seat setting with the flexible female seatbelt buckle being captured by the device; while being in the back bench of an automobile. The Belting is shown in an alternate position; to describe the functionality of the mounting plate.

FIG. 11: Top View of Retrofit Device Configuration consisting two overlapping mounting brackets, and mounting screws. Identical brackets flipped and assembled. This surrounding enclosure can also be configured from a single monolithic piece.

FIG. 12: Isometric View of Retrofit Device Configuration consisting two overlapping mounting brackets, and mounting screws. Identical brackets flipped and assembled.

FIG. 13: Front View of Retrofit Device Configuration consisting two overlapping mounting brackets, and mounting screws. Identical brackets flipped and assembled. The beveled perimeter is considered to prevent material damage to the seat.

FIG. 14: Side View of Retrofit Device Configuration consisting two overlapping mounting brackets, and mounting screws. Identical brackets flipped and assembled. The beveled perimeter is also considered to allow access to the seatbelt buckle button actuator.

FIG. 15: Exploded View of Retrofit Device Configuration consisting two overlapping mounting brackets, and mounting screws. Identical brackets flipped and assembled.

FIG. 16: Exploded with Hidden Lines View of Retrofit Device Configuration consisting two overlapping mounting brackets, and mounting screws. Identical brackets flipped and assembled.

FIG. 17A: Adjusting View of Retrofit Device Configuration consisting two overlapping mounting brackets, and mounting screws. Identical brackets flipped and assembled. This view shows the brackets at their minimum adjustment.

FIG. 17B: Adjusting View of Retrofit Device Configuration consisting two overlapping mounting brackets, and mounting screws. Identical brackets flipped and assembled. This view shows the brackets at an intermediate adjustment. The adjustment range in this configuration is preferably about one inch.

FIG. 18: Partial View of Retrofit Device Holster Configuration situated in a mounted booster seat setting to display how the retrofit device is mounted to a standard booster seat. This figure shows the flexible seatbelt buckle resting on the seat for upward support; through the open bottom of the surrounding enclosure.

FIG. 19: Full View of Retrofit Device Holster Configuration situated in a mounted booster seat setting, as in FIG. 18; but this full page view depicts the scale or size of the retrofit device. This view shows the device takes up about the same space as the size of the female seatbelt buckle.

FIG. 20: View of a sample Retrofit Device: both single and multiple belting mounting plate configurations. These mounting plates are shown in their simplest form for clarity. It is very possible to design and incorporate a mounting plate configuration with protruding loops, bends and other forms for the belting.

FIG. 21A: Partial View of incorporated Device Holster Configuration situated in a booster seat setting. This view shows the device is adjustable and retracted. The improved booster seat is manufactured with features to accept the adjustable holster.

FIG. 21B: Partial View of incorporated Device Holster Configuration situated in a booster seat setting. This view shows the device is adjustable and extended. The improved booster seat is manufactured with features to accept the adjustable holster.

FIG. 22: Partial View of incorporated Device Suspension Configuration situated in a booster seat setting. This view shows the improved booster seat is manufactured with features to accept the continuous or segmented belting.

FIG. 23: Partial View of incorporated Device of Suspension Configuration situated in a booster seat setting. This view shows the improved booster seat is manufactured with features to accept the continuous belting. It also shows how the continuous belting may be arranged.

FIG. 24: Partial View of incorporated Device of Suspension Configuration situated in a booster seat setting. This view shows the improved booster seat is manufactured with features to accept the segmented belting. It also shows an alternate of how the segmented belting may be arranged.

FIG. 25: Partial View of incorporated Device of Suspension Configuration situated in a booster seat setting. This view shows the device is adjustable with continuous belting and flexible female seatbelt buckle restrained. The improved booster seat is manufactured with features to accept the continuous belting.

FIG. 26A: Partial View of incorporated Device of Holster Configuration situated in a booster seat setting. This view shows the device is adjustable with vertical swing motion to extend and retract the holster configuration. The improved booster seat is manufactured with features to accept and conceal the device in the stowage position. This figure shows the device in the extended position.

FIG. 26B: Partial View of incorporated Device of Holster Configuration situated in a booster seat setting. This view shows the device is adjustable with vertical swing motion to extend and retract the holster configuration. The improved booster seat is manufactured with features to accept and conceal the device in the stowage position. This figure shows the device in the transition position.

FIG. 26C: Full View of incorporated Device of Holster Configuration situated in a booster seat setting. This view shows the device is adjustable with vertical swing motion to extend and retract the holster configuration. The improved booster seat is manufactured with features to accept and conceal the device in the stowage position. This figure shows the device in the retracted position.

FIG. 27A: Partial View of incorporated Device of Holster Configuration situated in a booster seat setting. This view shows the device is adjustable with horizontal swing motion to extend and retract the holster configuration. The improved booster seat is manufactured with features to accept and conceal the device in the stowage position. This figure shows the device in the extended position.

FIG. 27B: Partial View of incorporated Device of Holster Configuration situated in a booster seat setting. This view shows the device is adjustable with horizontal swing motion to extend and retract the holster configuration. The improved booster seat is manufactured with features to accept and conceal the device in the stowage position. This figure shows the device in the transition position.

FIG. 27C: Full View of incorporated Device of Holster Configuration situated in a booster seat setting. This view shows the device is adjustable with horizontal swing motion to extend and retract the holster configuration. The improved booster seat is manufactured with features to accept and conceal the device in the stowage position. This figure shows the device in the retracted position.

FIG. 28A: Section View of incorporated Device of Holster Configuration situated in a booster seat setting. This view shows the device is adjustable with horizontal swing motion to extend and retract the holster configuration. The improved booster seat is manufactured with features to accept and conceal the device in the stowage position. This figure shows the device in the extended position. This section view adds to the detail of FIG. 27A showing the cavity and pivot point for manufacturing purposes.

FIG. 28B: Section View of incorporated Device of Holster Configuration situated in a booster seat setting. This view shows the device is adjustable with horizontal swing motion to extend and retract the holster configuration. The improved booster seat is manufactured with features to accept and conceal the device in the stowage position. This figure shows the device in the transition position. This section view adds to the detail of FIG. 27B showing the cavity and pivot point for manufacturing purposes.

FIG. 28C: Section View of incorporated Device of Holster Configuration situated in a booster seat setting. This view shows the device is adjustable with horizontal swing motion to extend and retract the holster configuration. The improved booster seat is manufactured with features to accept and conceal the device in the stowage position. This figure shows the device in the retracted position. This section view adds to the detail of FIG. 27C showing the cavity and pivot point location for manufacturing purposes.

FIG. 29: Top View of Retrofit Device, Saddling Mounting Plate Configuration showing two clearance slots provided for pinch-free belt flow. Identical through slots are available for both left and right hand applications.

FIG. 30: Isometric View of Retrofit Device, Saddling Mounting Plate Configuration showing two saddling edges provided for the female seatbelt buckle. Identical rigid saddles are available for both left and right hand applications.

FIG. 31: Front View of Retrofit Device, Saddling Mounting Plate Configuration showing two belt access areas for the female seatbelt buckle belting. Identical belting access areas are available for both left and right hand applications. The access area design is provided for quick and easy loop threading.

FIG. 32: Side View of Retrofit Device, Saddling Mounting Plate Configuration showing two bent tabs used to create the offset necessary to saddle the female seatbelt buckle and loop the belting. Identical bent tabs are available for both left and right hand applications.

FIG. 33: Isometric View of Retrofit Device, Saddling Mounting Plate Configuration showing flexible female seatbelt buckle in stabilized position using only one belting.

FIG. 34: Side View of Retrofit Device, Saddling Mounting Plate Configuration showing flexible female seatbelt buckle in stabilized position using only one belting. The looping and saddling of the female seatbelt buckle and the Mounted Seatbelt Buckle Stabilizer is clearly shown in this figure and FIG. 33.

FIG. 35: View of Retrofit Device, Adapter or Buckle Extension Configuration showing one of many mounting features for a fixed or adjustable connection configuration. The flexible female seatbelt buckle in stabilized by connecting to this retrofit device. This view clearly shows an example of a simple modification required to convert a regular, existing, seatbelt buckle adapter or extension to a configuration of retrofit device. The modification is any selected feature required to connect the seatbelt buckle adapter to the booster seat.

FIG. 36: Views of incorporated device configuration showing one of many mounting features to accept a fixed or adjustable connection of the seatbelt buckle adapter configuration. These views also convey the idea that a retrofit concept may be derived simply by designing the internal features on the booster seat as a separate add-on hardware to be mounted on the exterior surface of an existing booster seat.

FIG. 37: Views of a working incorporated or a retrofit device configuration showing one of many mounting features to accept a fixed or adjustable connection of the seatbelt buckle adapter configuration. These views show the new modified Seatbelt Buckle Adapter in the up and down position to demonstrate the versatility to adjust to various flexible seatbelt buckles, while at the same time, a working and stowage position is perceived.

FIGS. 38A-D: show the four views of a working example of the incorporated seatbelt buckle stabilizer retrofit configuration in its formed state showing how it is supposed to function. These figures also show the incorporated seatbelt buckle stabilizer booster seat cover is comprised of necessary cutouts to provide access to the auxiliary features of the booster seat application which includes but, not limited to, the incorporated arm rest and cup holder features of an existing booster seat.

FIGS. 39: show the isometric view of a working example of the incorporated seatbelt buckle stabilizer retrofit configuration in its formed state showing how it is supposed to function with a partially covered seat attachment configuration. The partially covered seat attachment configuration shown may be comprised of necessary cutouts to provide access to the auxiliary features of the booster seat application which includes but, not limited to, the incorporated arm rest feature of an existing booster seat.

FIG. 40: show the isometric view of a working example of the incorporated seatbelt buckle stabilizer retrofit configuration in its formed state showing how it is supposed to function with an arm rest attachment configuration. The arm rest attachment configuration shown may be comprised of necessary cutouts to provide access to the auxiliary features of the booster seat application which includes but, not limited to, the incorporated arm rest feature of an existing booster seat.

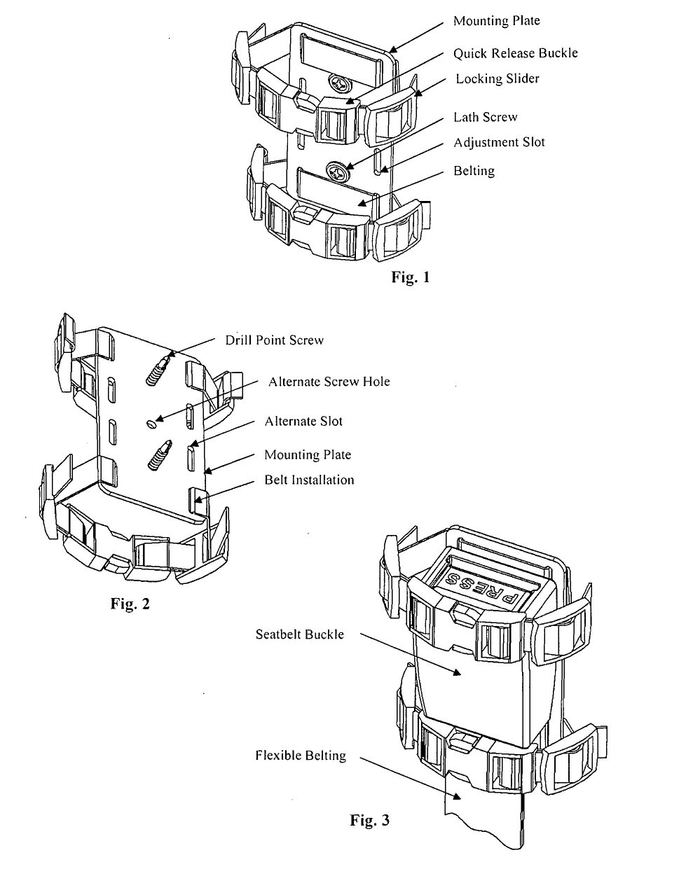

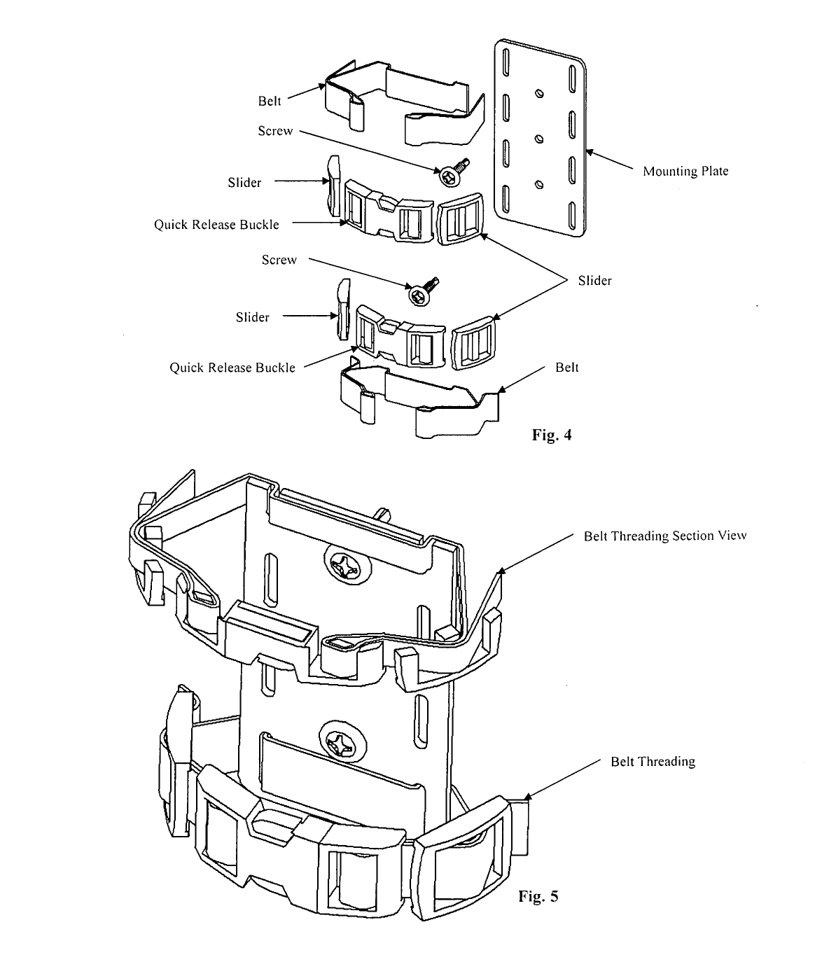

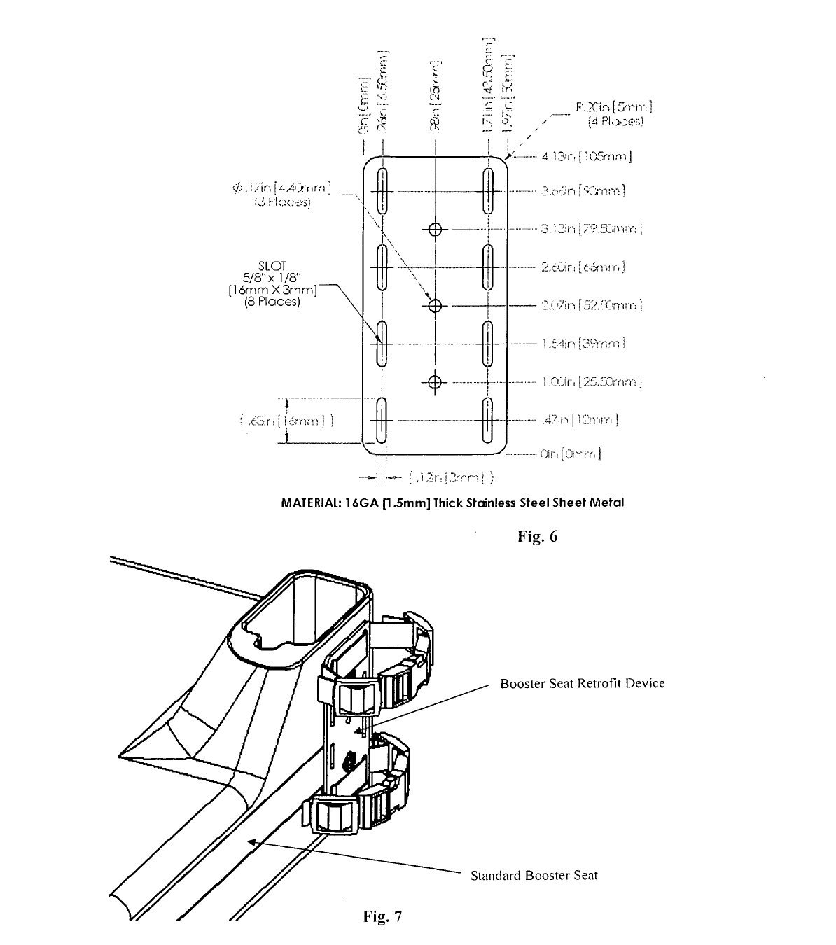

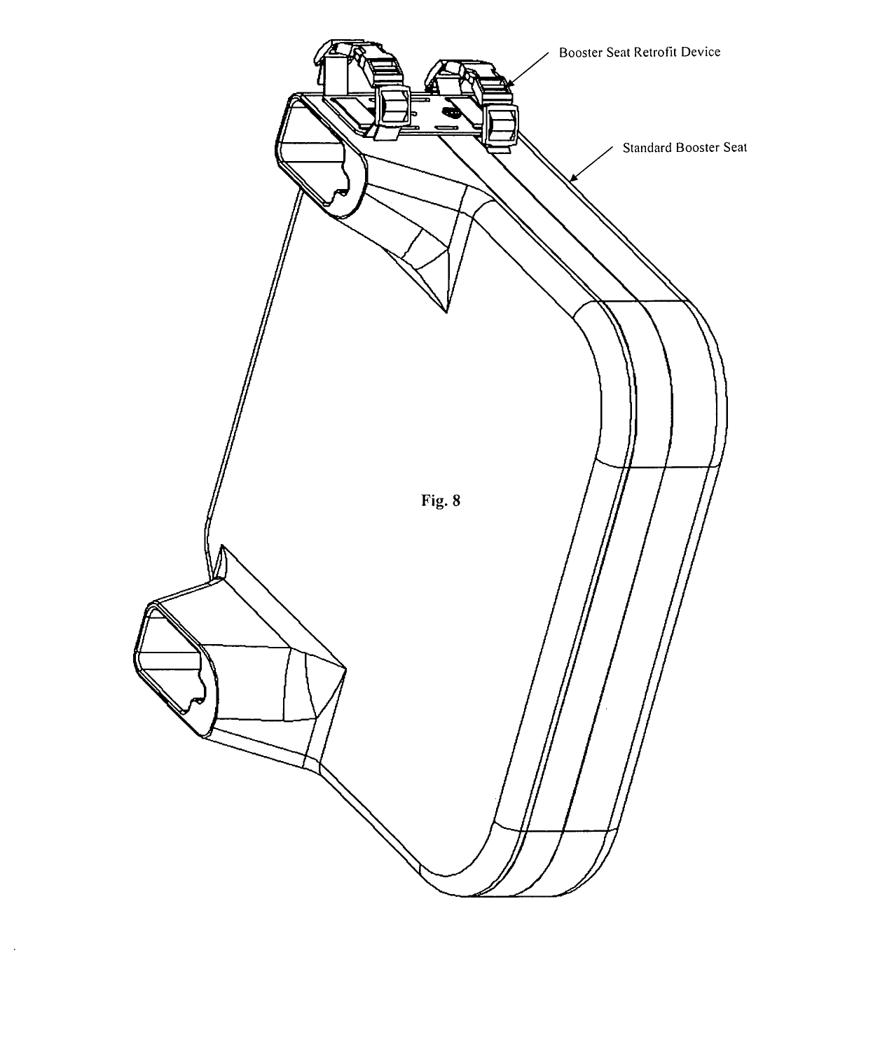

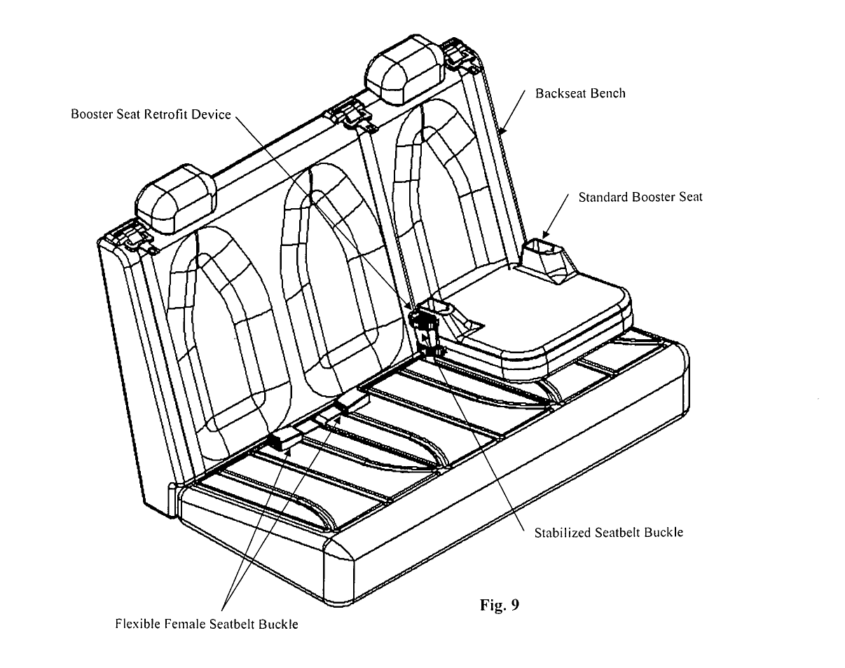

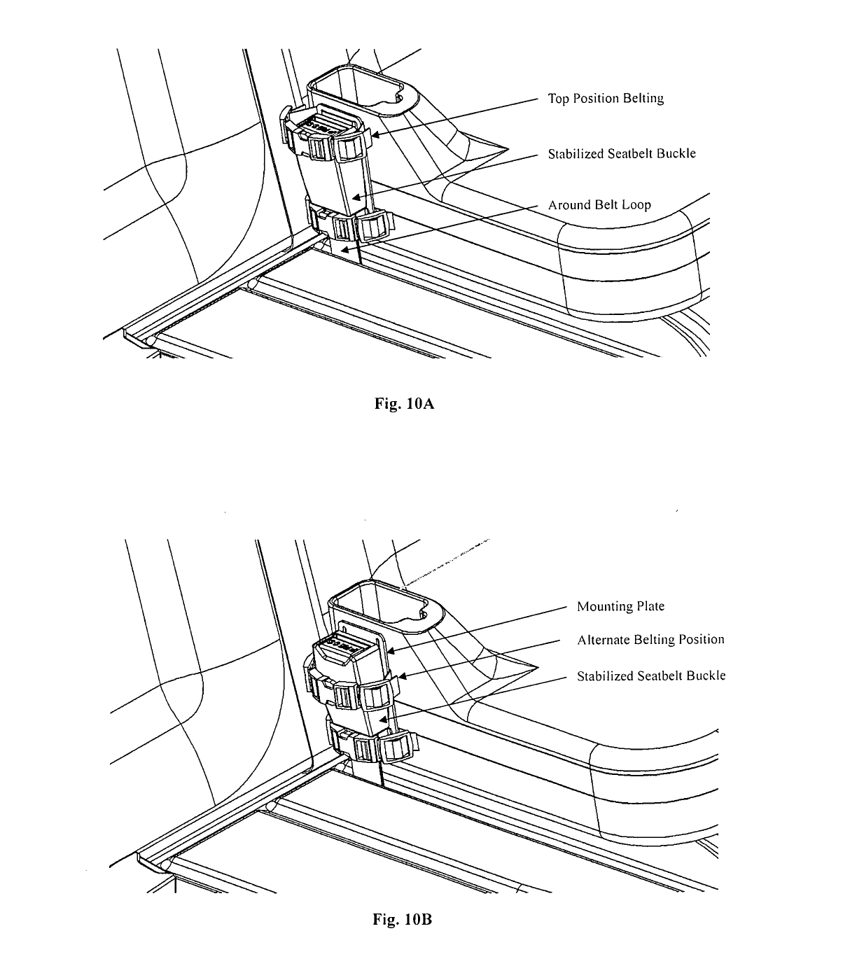

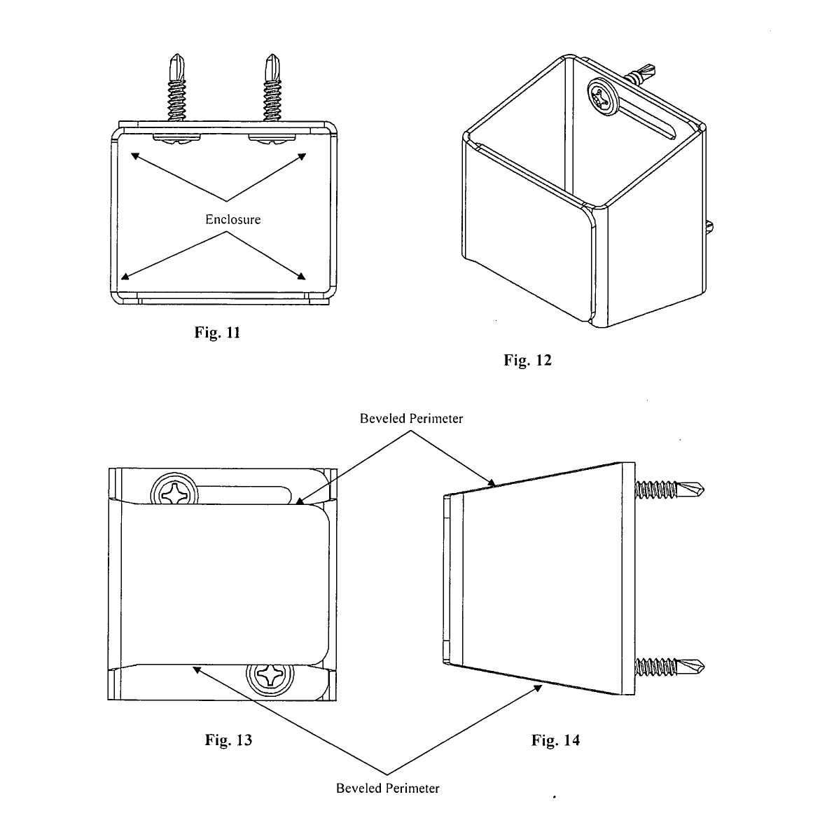

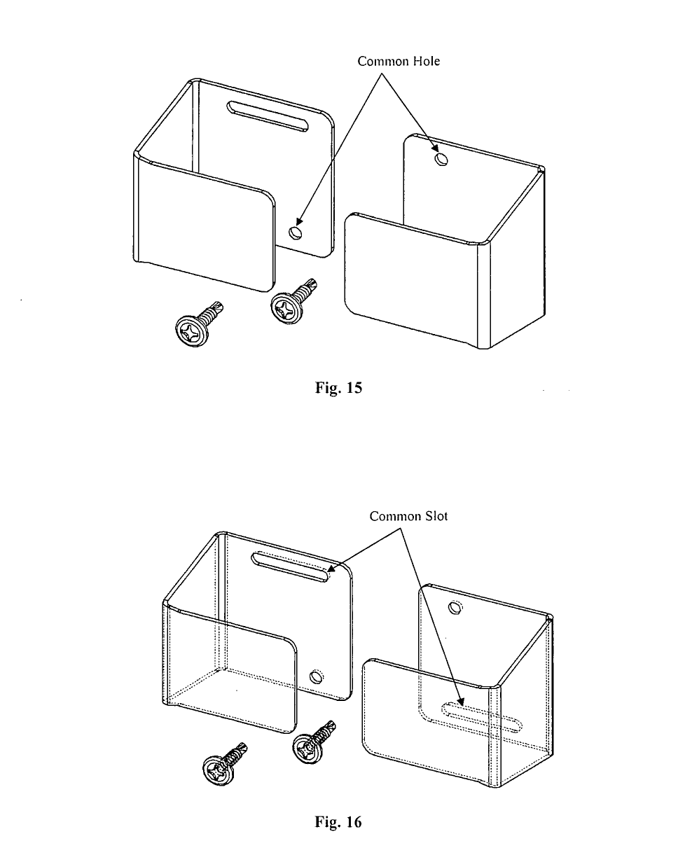

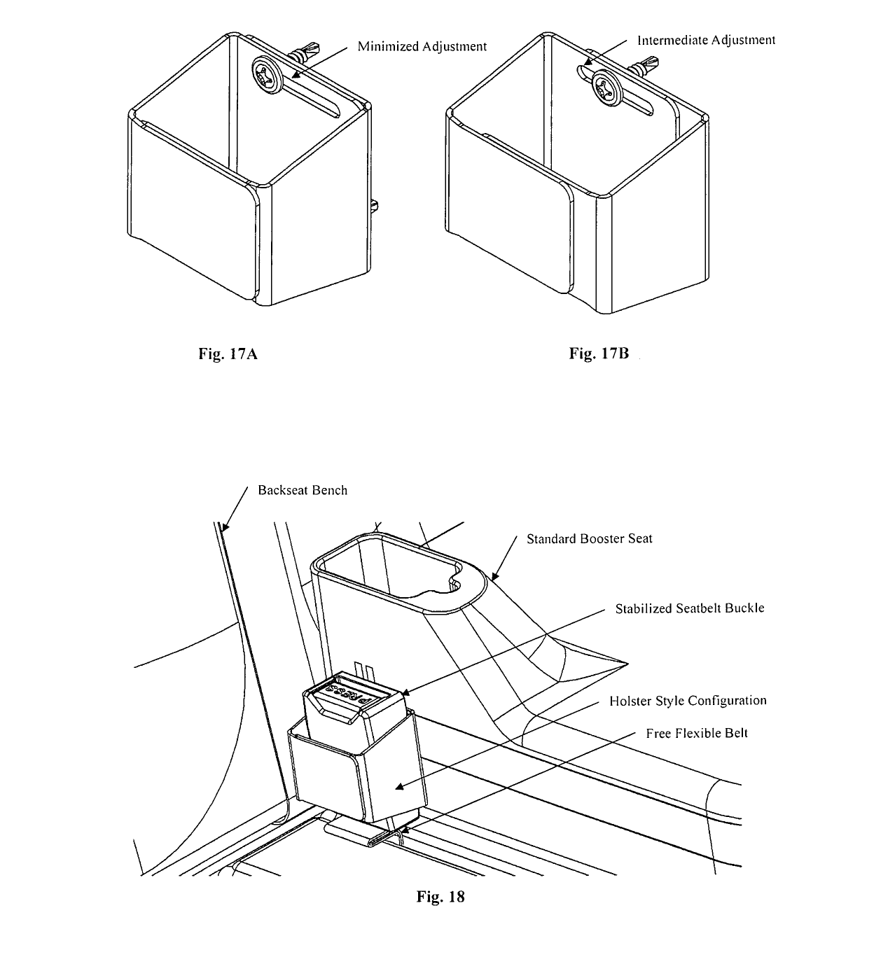

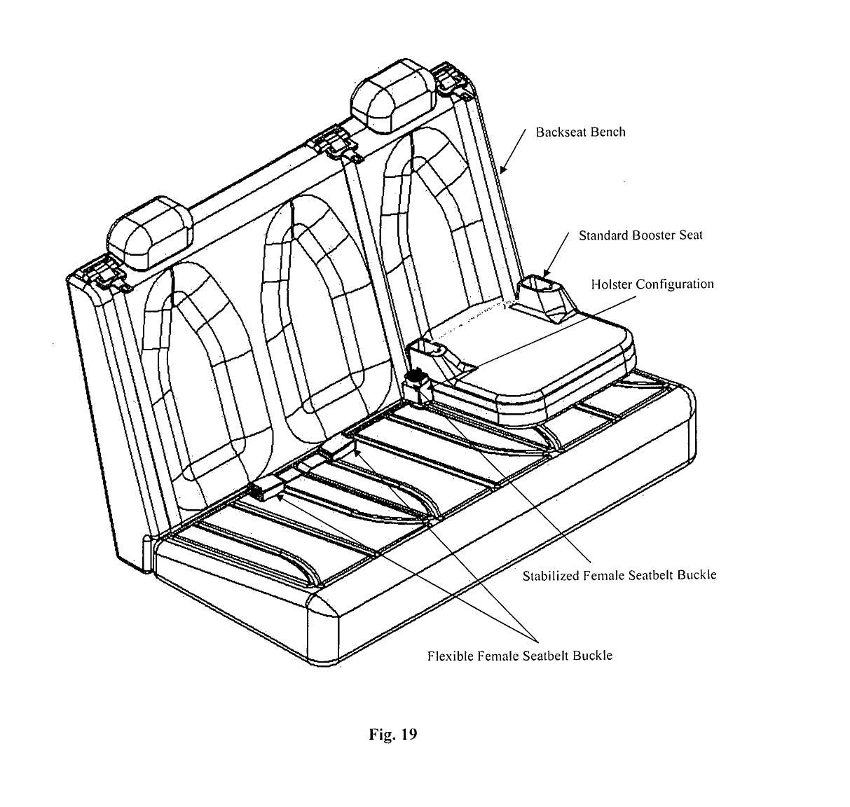

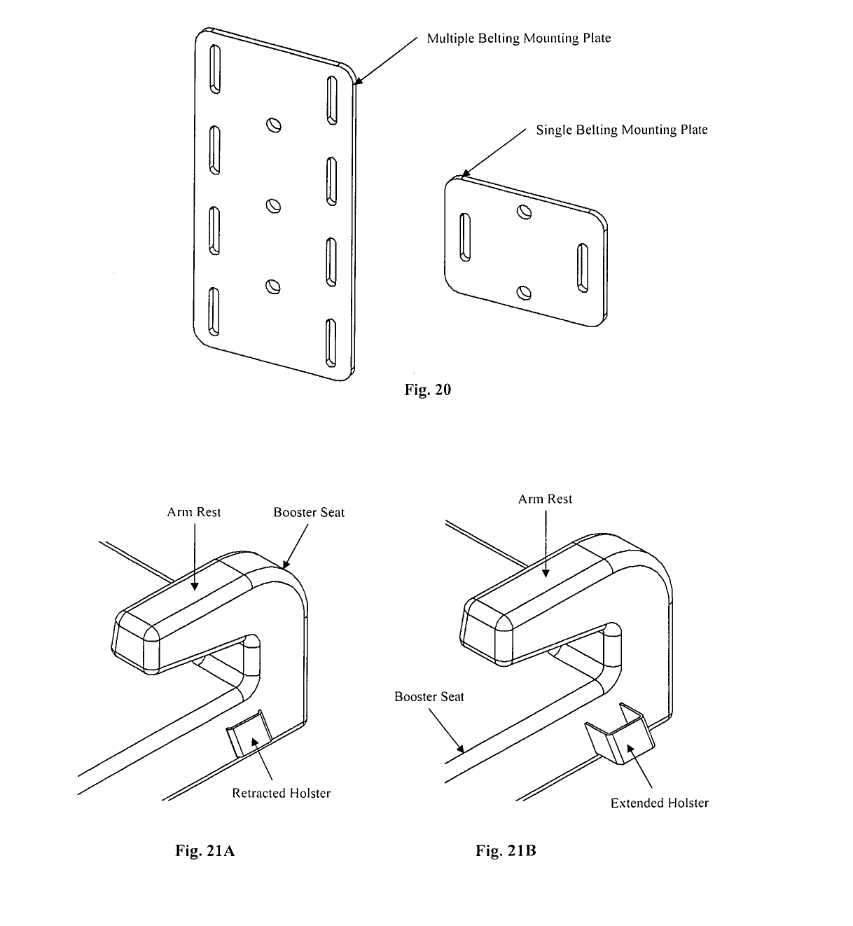

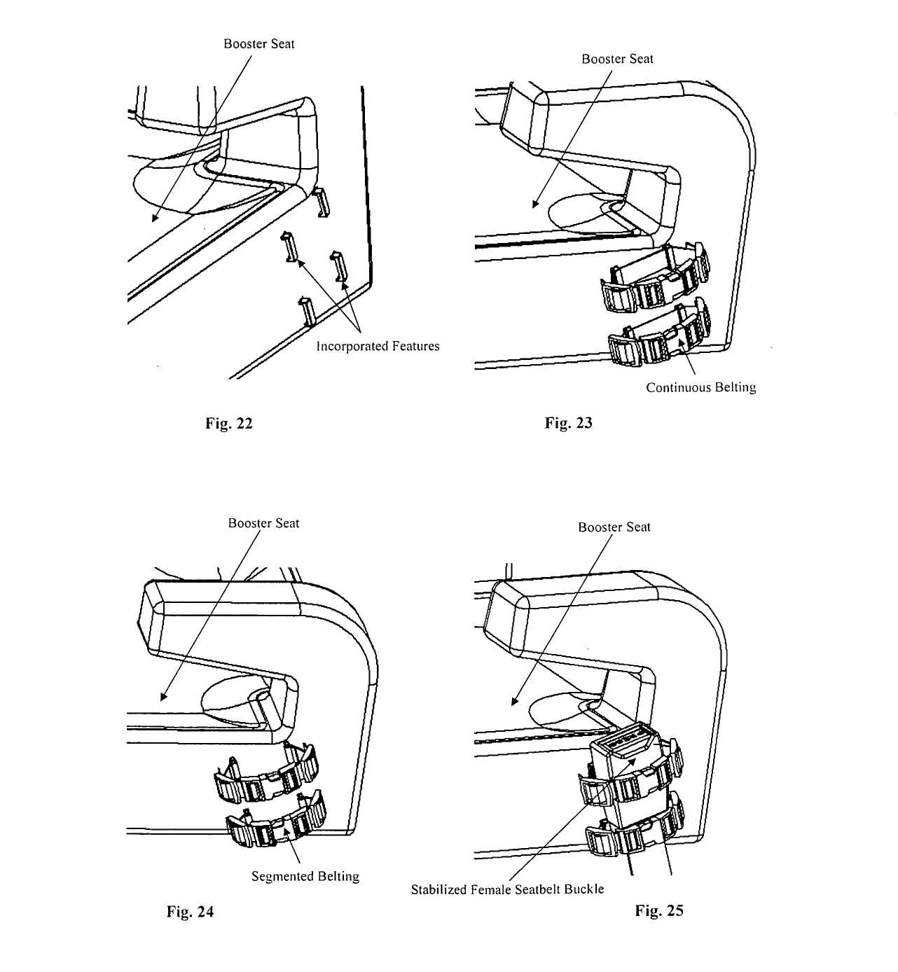

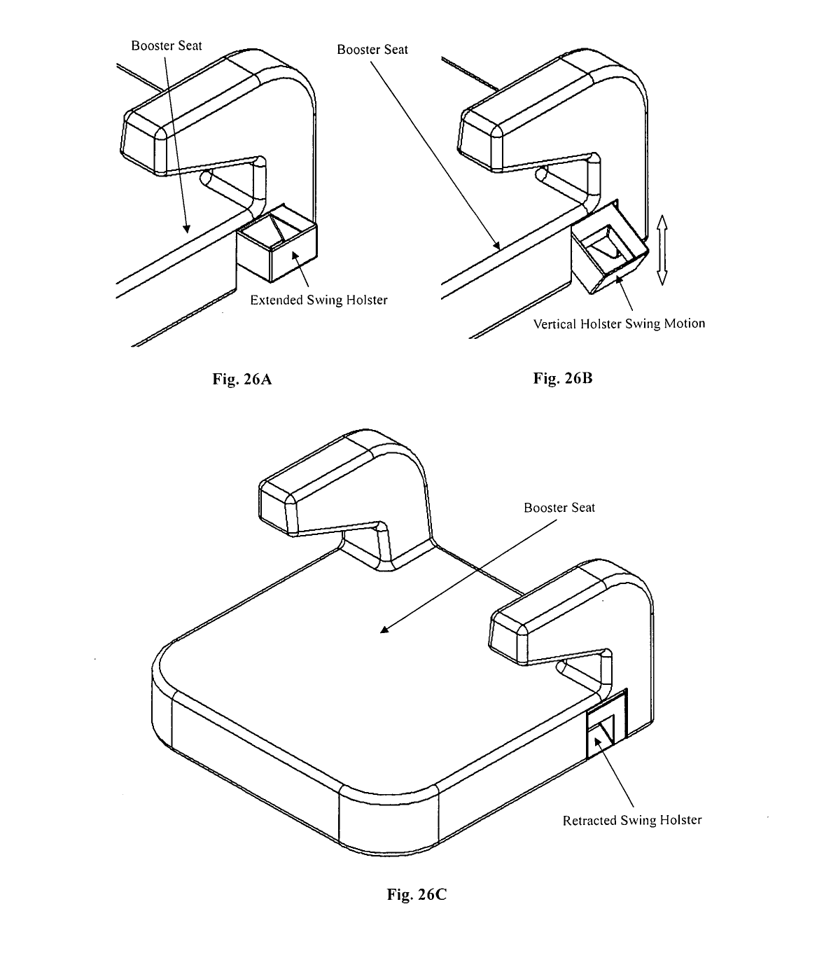

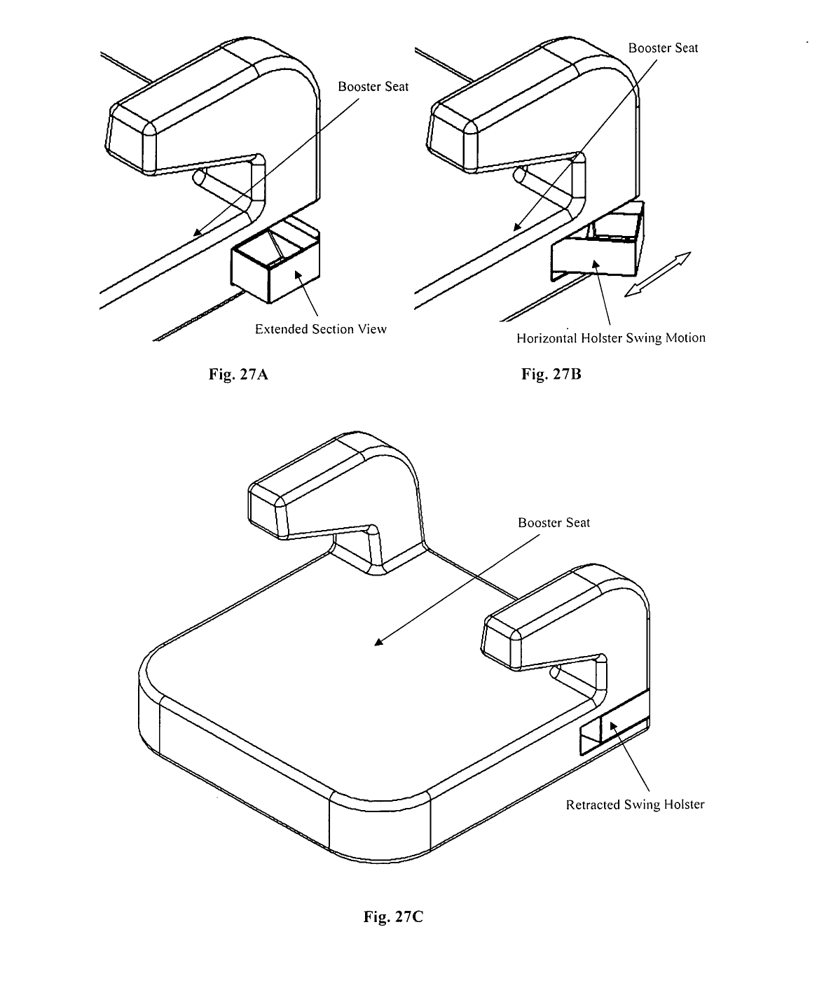

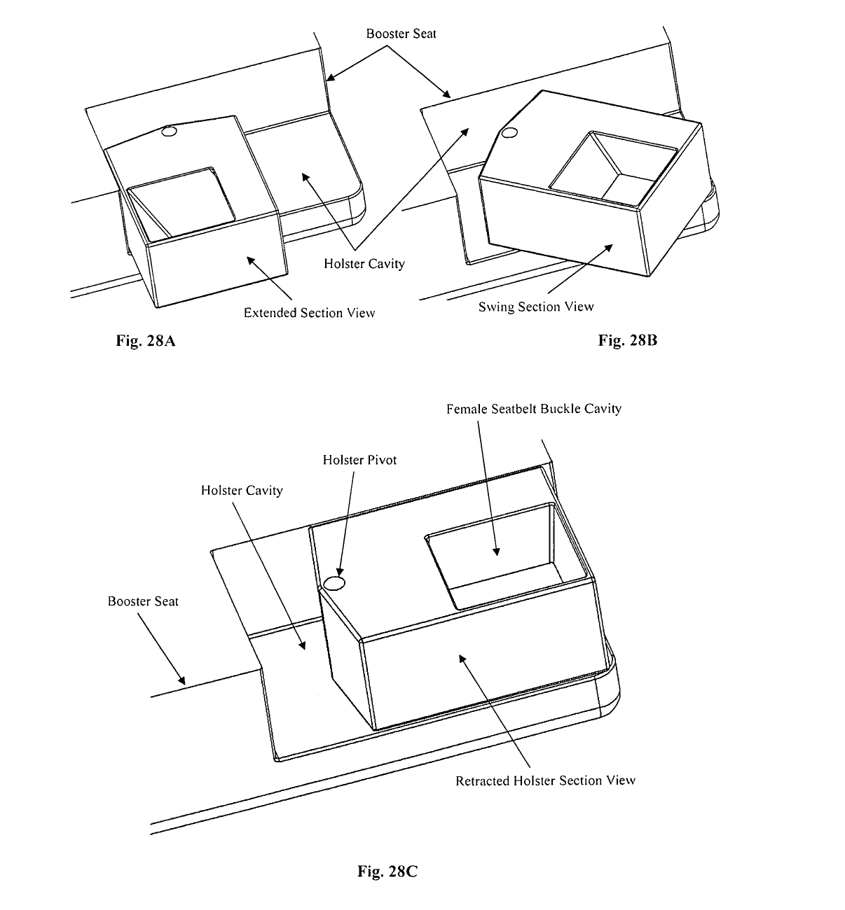

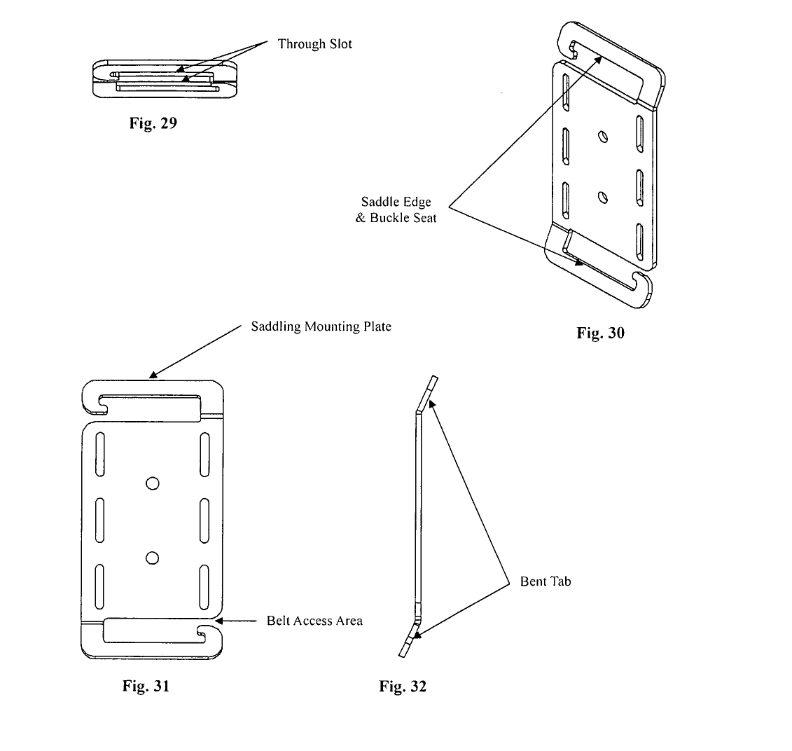

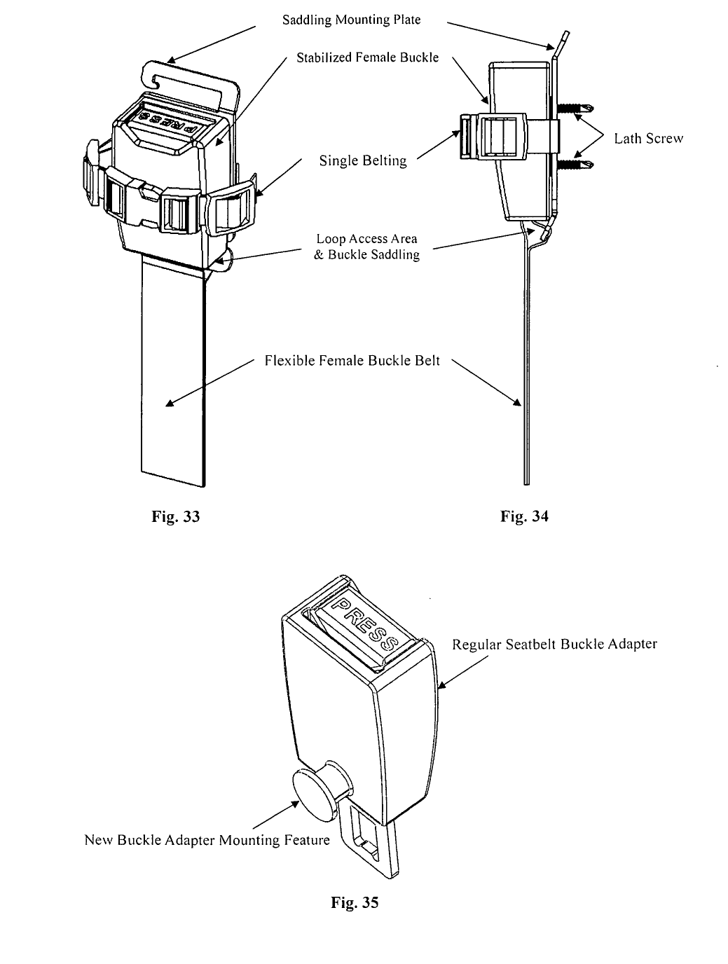

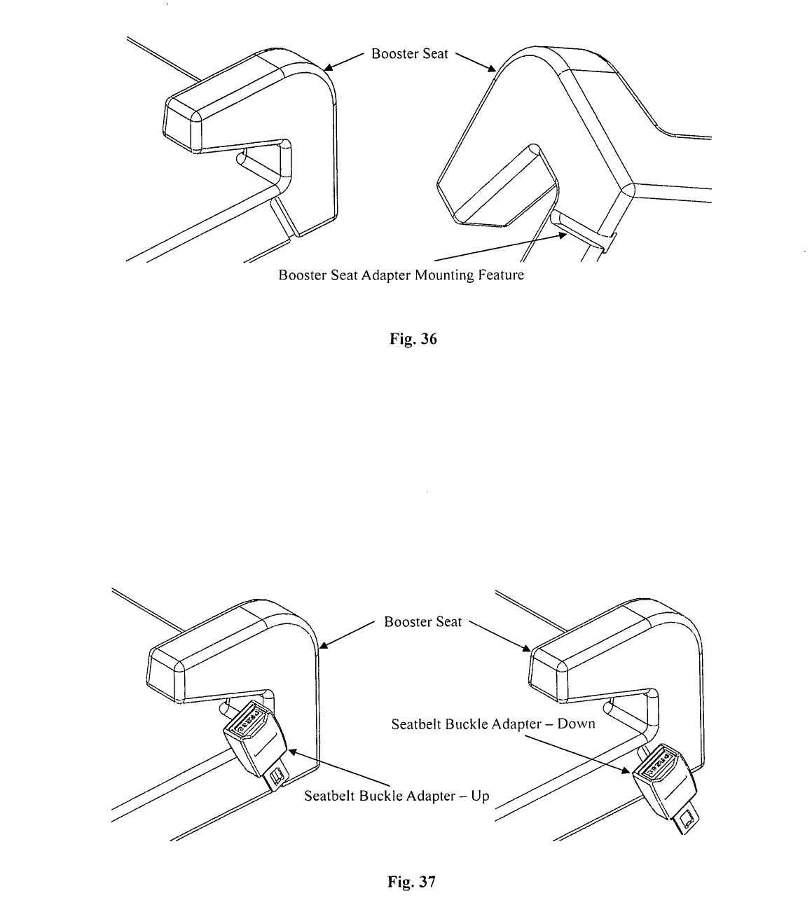

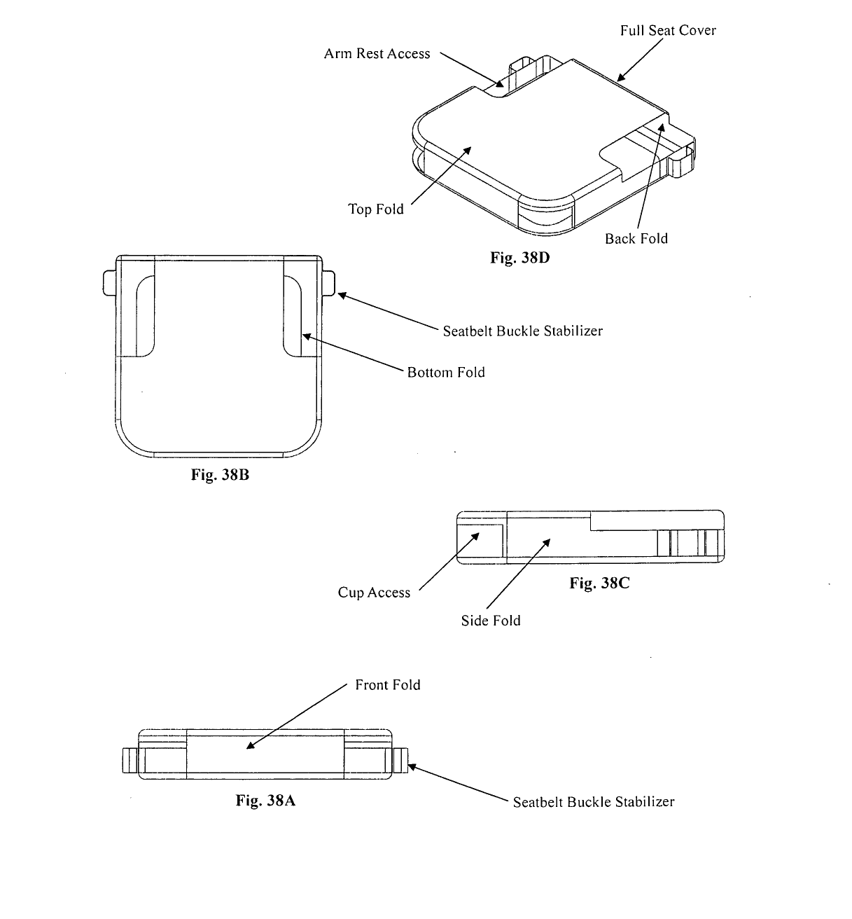

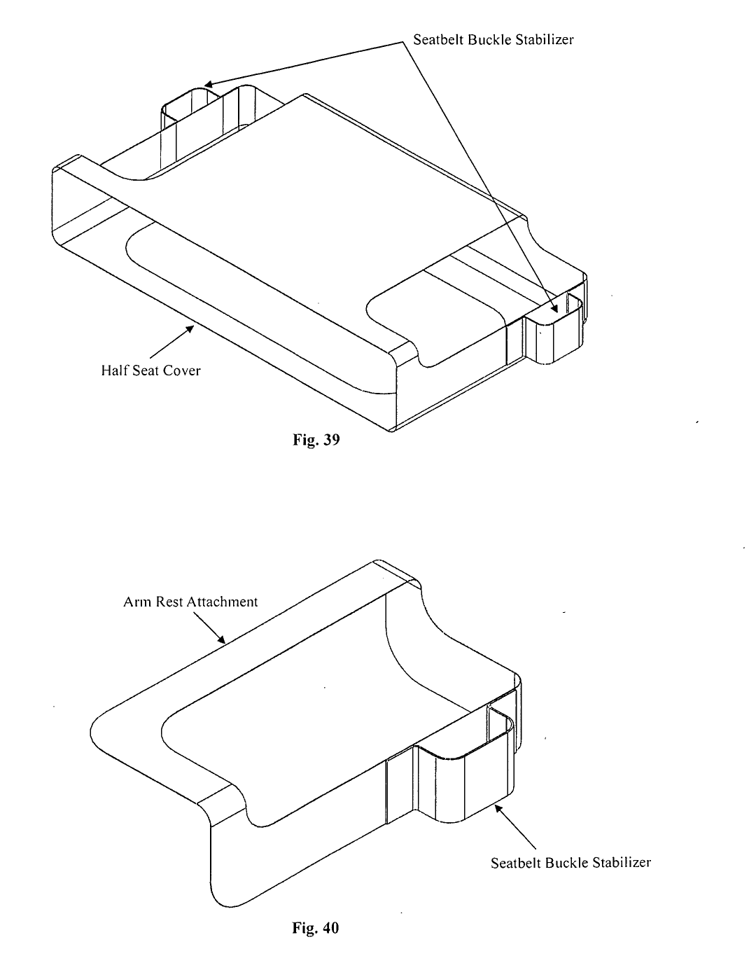

### VARIATIONS

It is contemplated, that any optional feature of the inventive variations described may be set forth and claimed independently, or in combination with any one or more of the features described herein. Reference to a singular item, includes the possibility that there is a plurality of the same items present.

More specifically, as used herein and in the appended claims, the singular forms “a,” “an,” “said,” and “the” include plural referents unless specifically stated otherwise. In other words, use of the articles allow for “at least one” of the subject item in the description above as well as the claims made herein. It is further noted, that the claims may be drafted to exclude any optional element. As such, this statement is intended to serve as antecedent basis for use of such exclusive terminology as “merely,” “solely,” “only” and the like in connection with the recitation of claim elements, or use of a “negative” limitation.

Without the use of such exclusive terminology, the term “comprising” or “comprised” in the claims shall allow for the inclusion of any additional element irrespective of whether a given number of elements are enumerated in the claim, or the addition of a feature could be regarded as transforming the nature of an element set forth in the claims. Except as specifically defined herein, all technical and scientific terms used herein are to be given as broad a commonly understood meaning as possible while maintaining claim validity. The breadth of the present invention is not to be limited to the examples provided and/or the subject specification, but rather only by the scope of the claim language.

Use of the term “invention” herein is not intended to limit the scope of the claims in any manner. Rather it should be recognized that the “invention” includes the many variations explicitly or implicitly described herein, including those variations that would be obvious to one of ordinary skill in the art upon reading the present specification. Further, it is not intended that any section of this specification (e.g., the Summary, Detailed Description, Abstract, Field of the Invention, etc.) be accorded special significance in describing the invention relative to another or the claims. All references cited are incorporated by reference in their entirety. Although the foregoing invention has been described in detail for purposes of clarity of understanding, it is contemplated that certain modifications may be practiced within the scope of the appended claims.

1. A booster or child seat mechanical hardware retrofit device comprised of the systematic stabilization of any flexible seatbelt buckle or other unstable objects.

2. A booster or child seat functional non-intrusive fabric covering or pull-over retrofit device comprised of the systematic stabilization of any flexible seatbelt buckle or other unstable objects as an incorporated feature into the fabric of said device.

3. A booster or child seat device comprised of the systematic stabilization of any flexible seatbelt buckle or other unstable objects as an incorporated feature into a booster or child seat.

4. The booster or child seat device of claims 1, 2, and 3, having the capability of retaining (receiving and holding) proximity objects via fixed or adjustable belting to it.

5. The booster or child seat device of claims 1, 2, and 3, having the capability of automatically transferring the Mounted Seatbelt Buckle Stabilizer functionality with the booster seat from one vehicle or location to the next.

6. The booster or child seat device of claims 1, 2, and 3, having the capability of stabilizing the flexible female seatbelt buckle in a suspension manner.

7. The booster or child seat device of claims 1, 2, and 3, having the capability of stabilizing the flexible female seatbelt buckle in an enclosure or holster manner; where by the seat of the bench is used as the support structure for the buckle and the enclosure creates the overturning stabilization.

8. The booster or child seat device of claims 1, 2, and 3, having the capacity to quickly and easily snap-in or snap-out the device stabilizing technology on-to and off-of the seatbelt buckle.

9. The booster or child seat device of claims 1, 2, and 3, having the capacity to quickly and easily glide-over or glide-out the device stabilizing technology on and off the seatbelt buckle.

10. The booster or child seat device of claims 1, 2, and 3, having the capability of retaining the free-to-slide booster from freely sliding; regardless of whether the seatbelt is being used or not (Anti-Submarine Technology Incorporated).

11. The booster or child seat device of claims 1, 2, and 3, wherein the mounting bracket design can be configured for a single fixed belting position or a multiple of adjustable belting positions per bracket and booster seat (typically symmetric for both right hand and left hand access).

12. The booster or child seat device of claims 1, 2, and 3, wherein the mounting bracket design can be configured to apply suspending flexible belting, and a flexible or rigid saddling through the attaching loop of the flexible female seatbelt buckle to create a saddle-like supporting seat.

13. The booster or child seat device of claims 1, 2, and 3, wherein the selected attachment design is configured, as fixed or adjustable, and applied in a similar fashion as a modified regular seatbelt buckle adapter or extension device.
